(19) United States
(12) Patent Application Publication
(10) Pub. No.: US 2023/0100053 A1
(43) Pub. Date: Mar. 30, 2023

(54) METHOD AND APPARATUS FOR MULTI-POINT RAMAN SPECTROSCOPIC ANALYSIS VIA OPTICAL MULTIPLEXING

(71) Applicant: Purdue Research Foundation, West Lafayette, IN (US)

(72) Inventors: Joseph V Sinfield, West Lafayette, IN (US); Yu-Chung Lin, Harvard, MA (US)

(21) Appl. No.: 17/940,970

(22) Filed: Sep. 8, 2022

Related U.S. Application Data
(60) Provisional application No. 63/242,786, filed on Sep. 10, 2021.

(51) Int. Cl. G01J 3/44; G01J 3/02; G01N 21/65

(52) U.S. Cl. CPC G01J 3/44; G01J 3/0218; G01N 21/65

(57) ABSTRACT

A Raman spectroscopy system, including an optical excitation source, an objective lens, a mirror for redirecting optical excitation to the objective lens, an optical switch, an excitation beam optical fiber operationally connected to the objective lens and to the optical switch, a plurality of Raman probes, a plurality of probe optical fibers, each respective probe optical fiber operationally connected to the optical switch and a respective Raman probe, and a spectrometer. Each respective Raman probe is operationally connected to the spectrometer.

### CROSS-REFERENCE TO RELATED APPLICATIONS

This patent application claims priority to co-pending U.S. Provisional Patent Application Ser. No. 63/242,786, filed on Sep. 10, 2021, which is incorporated by reference herein.

### TECHNICAL FIELD

This disclosure relates generally to analytical chemistry, and, more specifically, to a method and apparatus for spatial environmental monitoring via Raman spectroscopy.

### BACKGROUND

This section introduces aspects that may help facilitate a better understanding of the disclosure. Accordingly, these statements are to be read in this light and are not to be understood as admissions about what is or is not prior art.

The need for environmental protection among the public has increased as populations have become increasingly aware of environment-related factors that adversely influence human health. Many such environmental concerns are related to water and groundwater due to the fact that water can easily carry contaminants and transport them over vast distances across different stages in the water cycle. With precipitation, surface and subsurface contaminants can wash into surface water bodies, or infiltrate into the ground and remain in the subsurface pore water, where they can be transported into underground aquifers and/or taken up by plants. Depending on different land-use purposes, water contamination may stem from fertilizer and herbicides overuse, petroleum refinery leakage that makes groundwater unsafe, or any of an array of everyday industrial and residential activities. With these contexts in mind, many techniques have been employed to detect and/or monitor different contaminants in water, including use of Ion-Selective Electrodes (ISE), Fourier Transform Infrared Spectra (FT-IR), Raman Spectroscopy, UV Absorbance, and Gas Chromatography (GC)-based methods among many others.

However, the complexity of contaminants and the environment in which they exist makes it challenging and expensive to conduct broad detection and monitoring operations. Current typical soil and water contamination examination methods are usually pollutant specific. In addition, many of these approaches are not compatible with different characteristics of contaminants simultaneously (for example, the ISE probe for nitrates cannot be used for other chemical compounds, and GC is typically tuned for a specific compound). Simultaneously, although these techniques often offer low detection limits with high accuracy, they usually require retrieving samples from a site and separating the solution from the in-situ media. Other methods, such as spatial monitoring techniques including electromagnetics (such as Ground Penetrating Radar (GPR)), acoustic imaging, or LiDAR, though improved over the past years, cannot provide detailed subsurface information.

When monitoring a pollution site, information from several different locations often needs to be obtained to develop a comprehensive picture of actual site conditions. The volume of required information usually depends on the site size and monitoring timespan and is unfortunately often limited by available capital. For in-situ analysis, various techniques such as hand-held Raman spectrometers and portable gas chromatography systems have recently gained popularity. While these devices can provide quantitative chemical information, their detection thresholds are quite limited, they typically require some form of sample preparation, and/or are too delicate to be placed in-situ for long-term monitoring. These limitations tend to drive focused analysis or mapping activities that conserve time and money and fit within the performance capabilities of the instruments. These intentionally abbreviated operations can adversely impact data quality and continuity and thus ineffectively represent in-situ conditions compared to continuous monitoring, particularly as the data might be collected discretely, through limited periodic sampling, often with no data collection in unfavorable conditions such as during heavy precipitation.

Another approach to gathering environmental information from a site is to retrieve samples to analyze in off-site labs. However, the number of samples that can be taken is usually limited by the available time and budget. Sample transportation and storage are typically costly and bring uncertainty, as the conditions in both practices need to be controlled to prevent the sample from disturbance and degradation. Simultaneously, analyzing samples requires significant time (often several days), and the chemical compositions of samples could change (e.g., oxidation) by the time the sample is tested. There is also a time limit in which samples must be tested for compounds after retrieval to maintain quality control and ensure that the test result is representative of in-field conditions. For example, the maximum hold time for an environmental water sample to be validated for nitrate level is limited to 48 hrs after sampling, and the sample must be preserved below 6° C.

Beyond the technical challenges posed by environmental monitoring operations, sampling and laboratory analysis expenses can contribute to a significant portion of a project's budget. A long-term monitoring project can be very costly if traditional methods are applied, such as manually collecting groundwater samples for off-site analysis. Nearly 40,000 groundwater samples are retrieved per year, and each sample can cost thousands of US dollars for laboratory analyses. Additional noteworthy costs include the labor of sample collection, management, and sample disposal. Long-term monitoring costs often exceed the initial characterization and restoration costs. For long-term monitoring in a broad area, such as monitoring a watershed or from upstream to downstream of a river, the cost of sampling and analysis often can be uneconomical and limit the extent of space and time feasibly included in a monitoring project. In addition, the breadth of potentially encountered contaminants, variation in transport processes and the life cycle of chemicals in the natural environment, and influence of heterogeneous regional geology and land usage add to the complexity of achieving successful long-term monitoring operations. Undoubtedly, there is a need for a fieldable contaminant monitoring method that is affordable and suitable for long-term operation, offers accuracy, and that can be employed consistently at different locations and depths. Thus, there exists an unmet need for efficient, fast, and cost-effective measurement of environmental conditions. The present novel technology addresses this need.

### BRIEF DESCRIPTION OF THE DRAWINGS

FIG. 1A is a graphic representation of a first embodiment of the present novel technology, a method and apparatus for spatial environmental monitoring via Raman spectroscopy.

FIG. 1B is a graphic representation of the apparatus of FIG. 1A.

FIG. 2A schematically illustrates the apparatus of FIG. 1B configured in a first demultiplexer mode.

FIG. 2B schematically illustrates the apparatus of FIG. 1B configured in a second multiplexer mode.

FIG. 3A is a top view of a demultiplexer having a plurality of output ports.

FIG. 3B is a bottom view of a demultiplexer having a power input port.

FIG. 4 is a front plan view of a switch for moving between multiplexer and demultiplexer configurations.

FIG. 5 graphically illustrates the relation between Raman Shift and Intensity.

FIG. 6A graphically illustrates the relation between Wave Number and Intensity for switch and fibers used for the excitation side.

FIG. 6A graphically illustrates the relation between Wave Number and Intensity for switch and fibers used for the collection side.

FIG. 7 graphically illustrates the relation between Wave Number and Distance.

FIG. 8A graphically illustrates the relation between Distance and Detectable Concentration (currently available optical fibers).

FIG. 8B graphically illustrates the relation between Distance and Detectable Concentration (ideal optical fibers).

FIG. 8C graphically illustrates the relation between Photon Count and Concentration (currently available optical fibers) for various distances.

FIG. 8D graphically illustrates the relation between Photon Count and Concentration (ideal optical fibers) for various distances.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended.

The present invention is directed toward extending Raman spectroscopy to the field, to allow the benefit of Raman's broad applicability, sensitivity, and ability to perform quantitative analysis to be realized even in complex systems. Raman can be used to probe the subsurface without significant disturbance of the in-situ conditions, can perform quantitative analysis even in a complex soil matrix or turbid, fluorescence-prone environment, and can be performed in a single-sided testing geometry that provides accessibility to field settings without compromising elements of the system that may require protection from the outside environment, thereby making it a high potential solution for continuous field-operation at reasonable cost. With this awareness of Raman spectroscopy's applicability to analysis of aqueous systems, the convenience fiber optics brings as a waveguide, and the capability an optical switch serves for light redirection, the combination of these three core technologies enables a breakthrough in response to the in-situ long-term monitoring need.

While Raman spectroscopy has demonstrated an ability to detect a broad array of chemicals, and fiber optics have been employed with a variety of spectroscopic techniques in various detection scenarios, current combinations of spectroscopic systems and fiber optics are limited to simple closed-path systems. In these systems, an optical fiber is used to deliver excitation energy to a sampling location, and then another optical fiber is used to transmit collected Raman scattering from the sample to the detector. Detection is limited by the number of excitation sources and detectors available, in one-to-one pairings. The present novel technology improves upon this limitation by utilizing a multi-point sensing prototype leveraging the attractive elements of Raman spectroscopy and optical fiber transmission technologies.

An optical switch is a device that can redirect input radiation to one of several outputs. The optical switch is a two-way device in which radiation can enter from one switch port and be directed to exit from any other. Herein, the definition and concept of a multiplexer from electronics is used to characterize an optical switch since, as it has similar functionality, and is often referred to as the optical multiplexer. A multiplexer is defined as a device with multiple input ports and a single output port, while a demultiplexer has a single input port and multiple output ports.

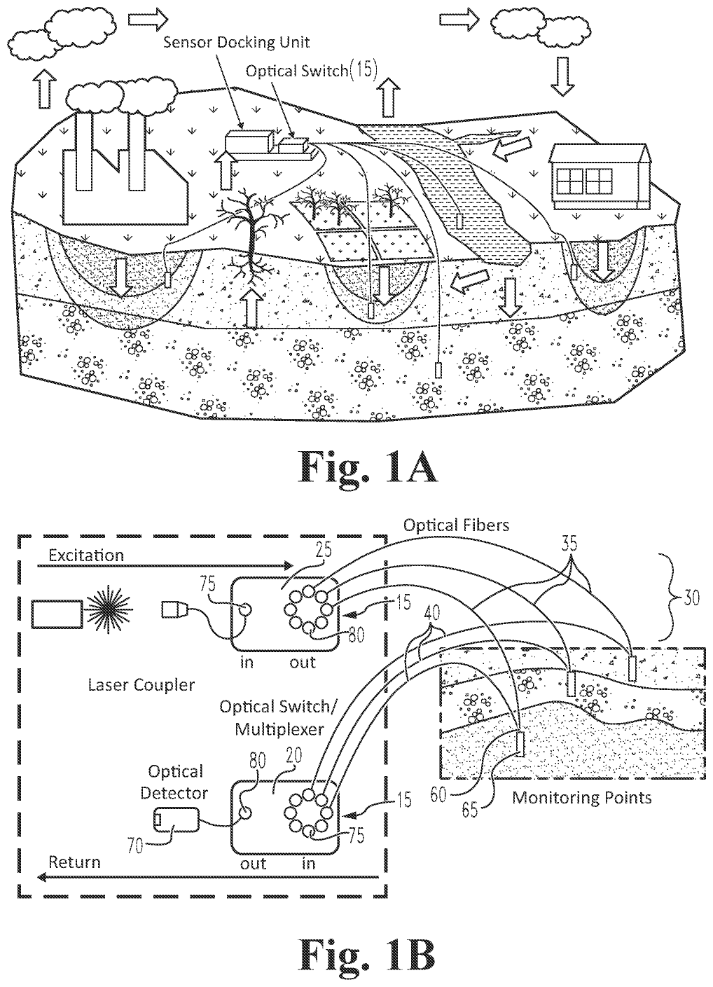

In an in-situ monitoring scenario, several Raman probes may be installed at different locations over a site with many monitoring locations. The excitation source may connect to a demultiplexer's single input port, and monitoring probes receive excitation inputs from the demultiplexer outputs. Instead of having several excitation sources, a single excitation source is redirected to each output, one at a time, and sent to Raman probes at desired testing locations via fiber optics. During monitoring, Raman scattering is collected by the probe and then sent to the collection multiplexer inputs, where it is transmitted from the multiplexer's single output to a detector for interpretation as a Raman spectrum. Similar to the excitation-side setup, only one detector is required for the whole system, thus lowering overall cost despite the system's expansive reach. FIG. 1 illustrates the in-situ setting of this system.

### EXAMPLE

In one embodiment Raman spectroscopy field detection system 10, a single switch 15 was used either as a demultiplexer 25 or a multiplexer 20, without applying two switches simultaneously. Optical fibers 30, including single-mode fibers 35 for excitation delivery and multi-mode fibers 40 for the return scattering transmission, were made into 1 m, 5 m, and 10 m lengths. Each length and the combinations of different lengths (10 m+5 m+1 m, 10 m+5 m, and 10 m+1 m, connected with mating sleeves) were used to for varying in-situ scenario distances between monitoring locations and the main source/detection docking unit.

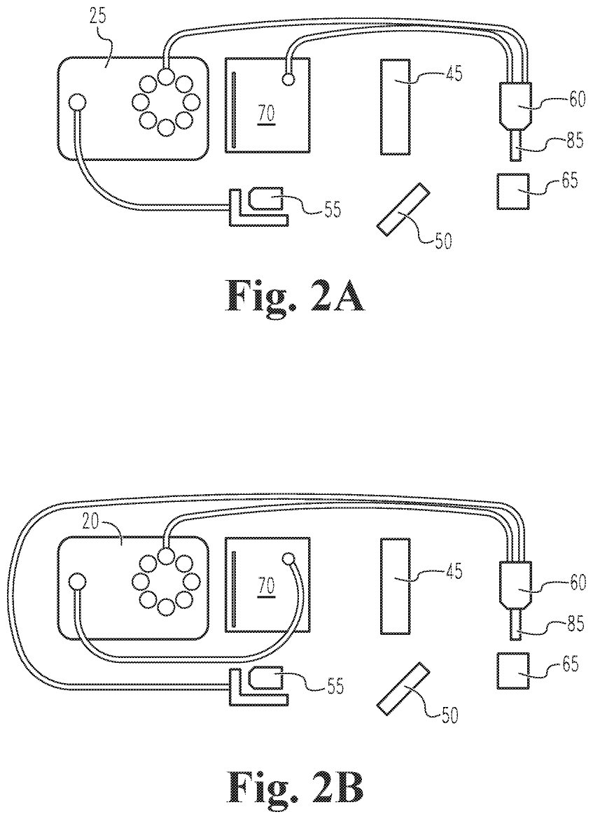

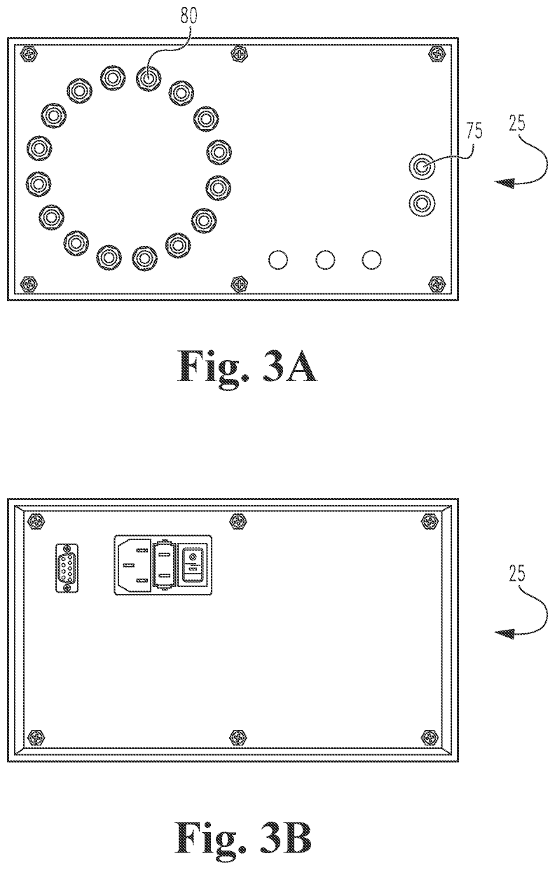

In this Example, the configuration enjoys a 532 nm Raman spectroscopy system. In this system setup, the excitation source 45 is a (1) 3 μJ laser. A mirror 50 (2) redirects the excitation 90°, and then an objective lens 55 (3) mounted on a fiber chuck focuses the excitation beam and couples it into optical fiber 35. FIGS. 2A-2B further depict the system in different configurations when using the optical switch 15 as a demultiplexer 25, and multiplexer 20. The connection between the CCD and PC is not shown.

When the optical switch 15 serves as a demultiplexer 25 (one excitation to one of the several outputs), the fiber optic 30 guides the excitation into the switch 15 (4). The excitation is then redirected via the switch 15 to the Raman probe 60 (5) which then guides the excitation beam to the sample 65 (6) and collects Raman scattering that is then directed to the CCD spectrometer 70 (7). The optical path is (1)->(2)->(3)->(4)->(5)->(6)->(5)->(7).

When testing the collection efficiency and the optical switch 15 is used as a multiplexer 20 (one detector that collects Raman scattering from one of several probe ports)), the optical path is (1)->(2)->(3)->(5)->(6)->(4)->(7).

Different lengths of optical fibers 30 were used to observe system transmission efficiency and in particular, losses due to the fibers 30, optical switch 15, and fiber connectors (mating sleeves) in the system 10. In this Example, optical fibers 30 were (S405-XP, single-mode 35 for excitation, loss <30 dB/km, and FG200LEA, multi-mode 40 for collection, loss <11 dB/km) for the configurations described herein. When observing the effects of fiber optics 30 on the excitation side, one 1 m optical fiber 35 was used to connect the fiber chuck and the switch 15, and three different lengths (1 m, 5 m, 10 m) and their combinations were used to connect the switch output 80 and the Raman probe 60, with one combination examined in any given experiment. When observing the effects of fiber optics 30 at the collection side, the settings were similar, but with the probe return fiber 40 connected to the switch input 75, and different lengths of optical fiber 40 used to connect between the switch output 80 and the CCD spectrometer 70.

The sample 65 used was a 5000 ppm nitrate-N aqueous solution prepared by dissolving KNO₃(s) into de-ionized water. The solution was stored in a glass cylinder with a nearly identical opening size as the Raman probe end. When testing, the Raman probe 60 is mounted on a vertical translational stage and is lowered to assure the probe's tip 85 is as close to the solution surface as possible but not immersed into the solution (note that waterproof probes are available but were not used here to limit cost and simplify experimentation). After lowering the probe 60 to the desired location, parafilm is wrapped around the top of the vial 65 and the Raman probe 60 to prevent evaporation.

The distance between the solution surface 65 and the probe tip 85 remained unchanged to avoid changing the light path length in the solution. Fifteen CCD exposures, each of ninety seconds, were obtained for each optical fiber length arrangement. In order to assess signal quality in each test, signal-to-noise ratio (SNR) was used to characterize Raman observations, defined as the average of the peak heights obtained from multiple acquisitions (the difference between the absolute peak height and the baseline height) divided by the standard deviation of the peak heights in the same data set. The exposure time was selected to ensure acquisition of a spectrum with a signal-to-noise ratio (SNR)>3 for tests with the maximum fiber length (16 m) (and therefore the maximum number of connectors used). In each exposure, the CCD was first exposed for same duration (90 seconds) as the test exposure, but with the laser off, to obtain dark background information. The dark background was then stored in a computer application and subtracted from the test spectrum after completing each test exposure.

The intensity recorded by the camera exposure was used to develop the Raman signature by integrating the charges accumulated on the CCD pixel array over time. A longer exposure time allows for the collection of as much light flux as possible for measurement but was ultimately limited as each CCD pixel has a saturation limit (full well). Noise from both the detector and the background inevitably contributes to the acquired signal, and therefore longer exposure time is not perpetually beneficial to the spectral quality.

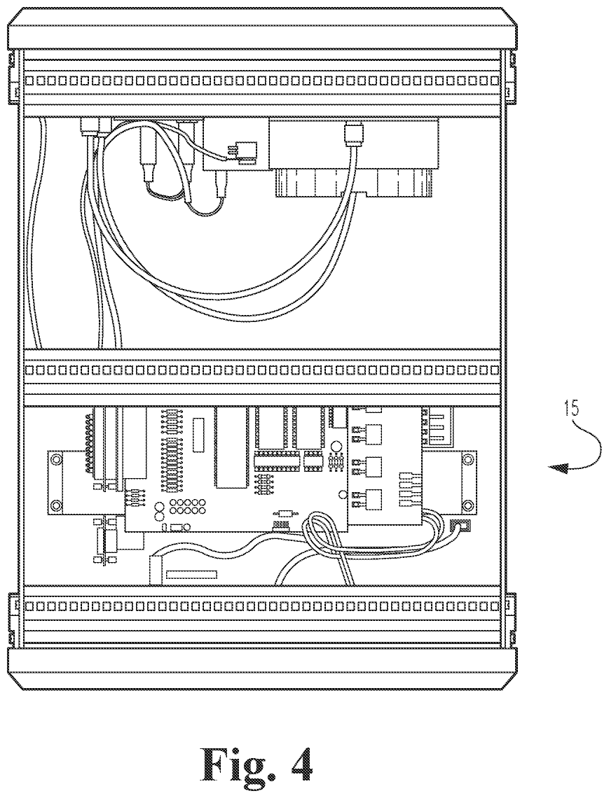

The multiplexer 25 had an optical throughput of greater than 60%. The switch assembly 15 and the switch's composition is relatively straightforward (see FIG. 4). The switch 15 has two input ports 80 and sixteen output ports 75 and is configured into two sets of a one-to-eight arrangement. In each arrangement, one fiber optic 30 connects the input interior and a rotary table containing two ports. When operating, the rotary table turns the port to the desired output showing on the switch front panel to deliver the radiation. As no information was available on the nature of the optical fibers used in the switch, the loss per unit length was assumed to be the same as the optical fibers used in the rest of the system. Additional losses are associated with all connectors. It is known that the losses within the fiber optics system mainly come from the connectors (mating sleeves). With this assumption in mind, a detailed summary of switch performance is provided, and further practical treatment recommendations are outlined below.

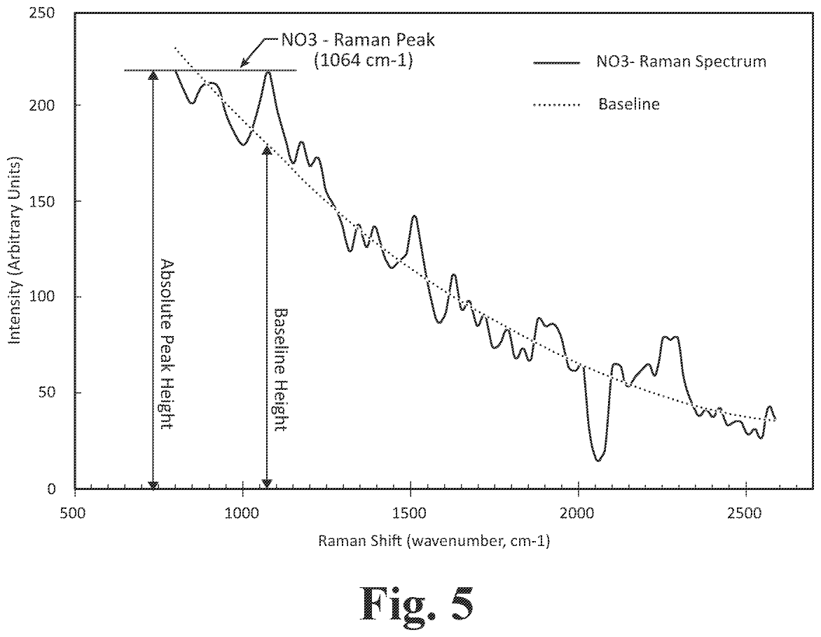

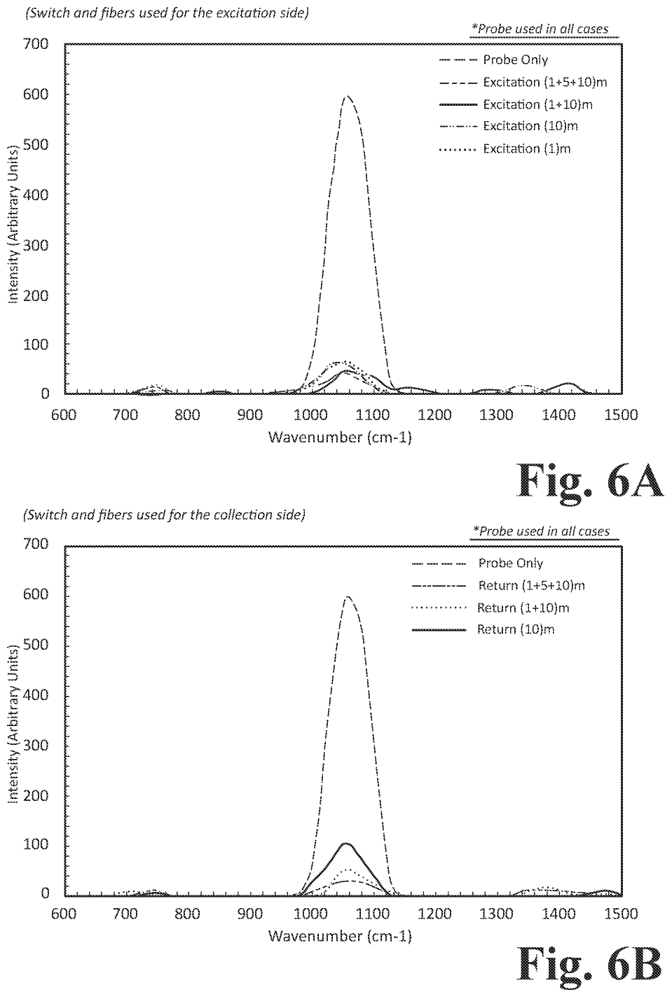

In order to assess the system's transmission efficiency, the peak height in each spectrum at the nitrate peak (1064 cm⁻¹) is obtained by subtracting the baseline height from the absolute height, as depicted in FIG. 5. The resulting Raman spectra of 5000 ppm NO₃—N(_{aq}) after the baseline correction under different test conditions, including utilizing the switch either on the excitation or the collection sides, are shown in FIG. 6. Each curve shown in the figures is the average of the fifteen acquired spectra.

The mean peak heights from each system configuration (different lengths of fiber optics) were calculated to find the SNR and, simultaneously, compared with the mean peak height from the tests that have only the Raman probe on the light path. Table 1 summarizes the results for the different test settings examined. This work involved connection of different lengths of optical fiber to test their influence on spectroscopic results. Therefore, the total length of the fiber and the total number of connectors are carefully examined and listed. The peak height ratios between the tests with fibers and the switch and the tests containing only the Raman probe are calculated to evaluate the losses due to the fiber optics and the connectors that are part of the multiplexing and distribution system. Because fiber loss per unit length (<11 dB/km for multi-mode fiber and <30 dB/km for single-mode fiber), insertion loss of the connectors (mating sleeves, <1.5 dB per connector for SMA-FC/PC and <1.4 dB for SMA-SMA), and the switch throughput (60%) are understood, the loss attributable to each component were determined.

As in each test case the length of the fiber optics is known, each connector loss (assuming connectors are the same) was found. Connections between different interfaces were taken to be the same type of connection (such as connecting fiber to fiber or fiber to the switch) and took into account every connection in the system. As listed in Table 1, the loss per connection was between 2.21 and 3.76 dB, with an average of 2.89 dB. This work then repeated the same process but considered the optical switch as two more connectors and one more twenty-cm optical fiber in the system (as shown in FIG. 4) and calculated the insertion losses as in Table 1. Assuming the connectors are the same as the rest in the system and the fiber optic inside the device is the same as the multi-mode external fiber used herein, the loss per connector is between 1.84 and 2.43 dB, with an average of 2.10 dB. In all cases, the insertion loss (connector loss) is larger than the noted value of 1.5 dB (SMA to SMA connectors) or 1.4 dB (SMA to FC/PC) in manufacturer's specifications.

The losses due to different lengths of fibers in different cases were notable (<11 dB/km for the multi-mode fiber and <30 dB/km for the single-mode fiber). However, the total length of fiber used in this Example is relatively short (<20 m in the longest case), and therefore, the total fiber loss is not significant (with a maximum of 3.1% when the single-mode fibers are used on the excitation side and no fibers are used on the collection side). For the purpose of deploying such a system in a real-world setting, the fiber and insertion losses observed in the Example would likely become unacceptable (i.e., driving an SNR <=3 for the analyte and concentration used here) at distances over 0.28 kilometers away from the sensing point. Higher quality fibers and connection methods would enable deployment of such a system for in-situ sensing. The losses in an ideal situation should be expected to be less than 1 dB/km for fiber (depending on the transmission wavelength), 0.30-0.75 dB for each mechanical connector, and 0.10-0.30 dB for each fused splice connection.

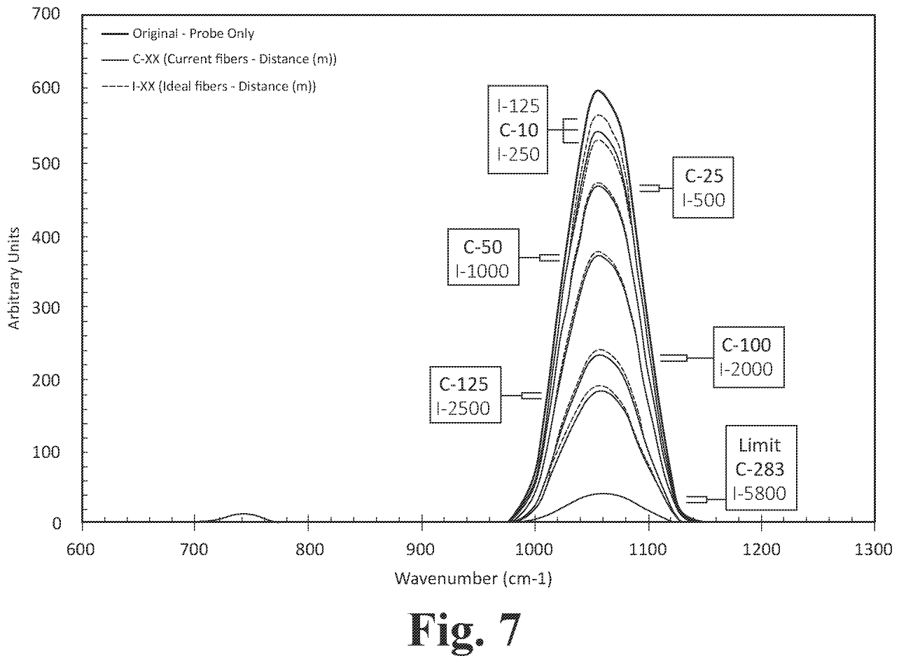

Using the above information, it is possible to assess the operating limits of the Example system and extrapolate a robust design. Assuming the baseline noise condition in the spectra remains the same under different conditions (a conservative assumption, as optical noise contributions will also attenuate), with no mechanical connections other than those required at the excitation-probe and probe-detector interfaces (similar to the current setup without extra fibers), and the same exposure time, to maintain an SNR >3 attenuation of 94% could be tolerated (from Cases 4 and 8 in Table 1). When using the current fibers, the maximum distance over which a successful Raman inquiry could be performed is thus approximately 280 m. In contrast, use of ideal or near-ideal fibers would enable reach of approximately 5800 m (loss <1 dB/km). FIG. 7 shows simulated nitrate response curves developed by combining the experimentally derived probe-only results obtained in this Example with different fiber lengths between the excitation/detector and the sensing locations, assuming that all connections are fused, or index matched, and single-piece fibers are used to reduce losses.

TABLE 1
Summary of multi-point Raman observations and connector loss estimation.

| | | | | | | (a) Switch as a “black box” | |
|---|---|---|---|---|---|---|---|
| | | | | | | Number | Fiber |
| | Configuration | | | | | of | Length |
| | Excitation | | Collection | Peak | | Interface | (m) |
| | Side*¹ | | Side*¹ | Height | SNR*² | Changes | Excitation |
| 1 | — | Probe | — | 593.47 | 38.87 | 1 | 1 |
| 2 | — | | ═1—s—10— | 101.23 | 10.74 | 2 | 1 |
| 3 | — | | ═1—s—1═10— | 55.63 | 6.69 | 3 | 1 |
| 4 | — | | ═1—s—1═5═10— | 32.90 | 4.71 | 4 | 1 |
| 5 | 1—s—1═ | | — | 61.64 | 6.91 | 2 | 3 |
| 6 | 1—s—10═ | | — | 59.81 | 6.70 | 2 | 12 |
| 7 | 1—s—10═1═ | | — | 48.72 | 4.02 | 3 | 13 |
| 8 | 1—s—10═5═1═ | | — | 41.10 | 3.76 | 4 | 18 |

| | (a) Switch as a “black box” | | (b) Switch components considered | | | |
|---|---|---|---|---|---|---|
| | | Insertion | Number | Fiber | | Insertion |
| | | Loss per | of | Length | | Loss per |
| | | Connector | Interface | (m) | | Connector |
| | Collection | (dB) | Changes | Excitation | Collection | (dB) |
| 1 | 1 | | 1 | 1.2 | 1 | |
| 2 | 12 | 2.65 | 4 | 1.2 | 12 | 1.88 |
| 3 | 13 | 2.63 | 5 | 1.2 | 13 | 2.02 |
| 4 | 18 | 2.53 | 6 | 1.2 | 18 | 2.05 |
| 5 | 1 | 3.76 | 4 | 3 | 1.2 | 2.43 |
| 6 | 1 | 3.69 | 4 | 12 | 1.2 | 2.40 |
| 7 | 1 | 2.75 | 5 | 13 | 1.2 | 2.09 |
| 8 | 1 | 2.21 | 6 | 18 | 1.2 | 1.84 |

*¹(—) represents a fiber-switch or a fiber-CCD connection.
(═) represents a fiber-fiber connection using a mating sleeve.
(s) represents the optical switch.
*²The SNR is defined as the average peak signal intensity over the standard deviation of the peak intensity. The excitation source and the CCD spectrometer are omitted in the table.

The losses identified in the above Example provide an opportunity to better understand and improve the design of future multiplexed systems, multi-point Raman spectroscopic analysis via optical multiplexing for in-situ monitoring. One option is to combine the Example system with a TRRS system that employs a PMT as a detector.

Achieving an SNR of 3 requires that the average signal peak intensity in repeated tests exceeds the standard deviation of the same peak intensity by a multiple of at least 3. Contributions to the standard deviation of the peak intensity stem from both fundamental variability in the number of scattered Raman photons generated by a given excitation energy, as well as system noise which may be both electrical and optical in nature. Fiber, being effectively immune to electromagnetic interference does little to change system noise parameters, and of course, has no effect on the general variability in the efficiency of the Raman phenomenon. Thus, the instant system's detection limit depends upon the potential to return Raman scattered photons to the detector in numbers that exceed three times the variability in those observations. In the current system, this limit occurs at approximately 5 ppm for nitrate-N, which is marked by observation of approximately 2300 photons. However, when observations are made at a distance, even if 2300 photons are available to collect and observe at the test location, losses in optical energy discussed above will reduce that number as a function of travel distance. Thus, building on the above outlined discussion of fiber loss in the current system, and making use of ideal commercially available fiber, it is possible to estimate detection limits as a function of distance. Effectively, the calibration curve is defined by the equation:

Nₚ=4.61×10²Cₐ (1)

where,
Nₚ is the number of counts observed, and Cₐ is the concentration of the analyte can be redefined due to the losses that will occur in the fiber optic system, such that,

Nₚₗ=4.61×10²Cₐ(Tₗ) (2)

where,
Nₚₗ represents the counts that would be observed at the detector for the analyte concentration C at the test location located a distance, l, from the detector, and Tₗ represents the fraction of the energy observed at the sensing location that will reach the detector. Here T is used to represent the transmittance.

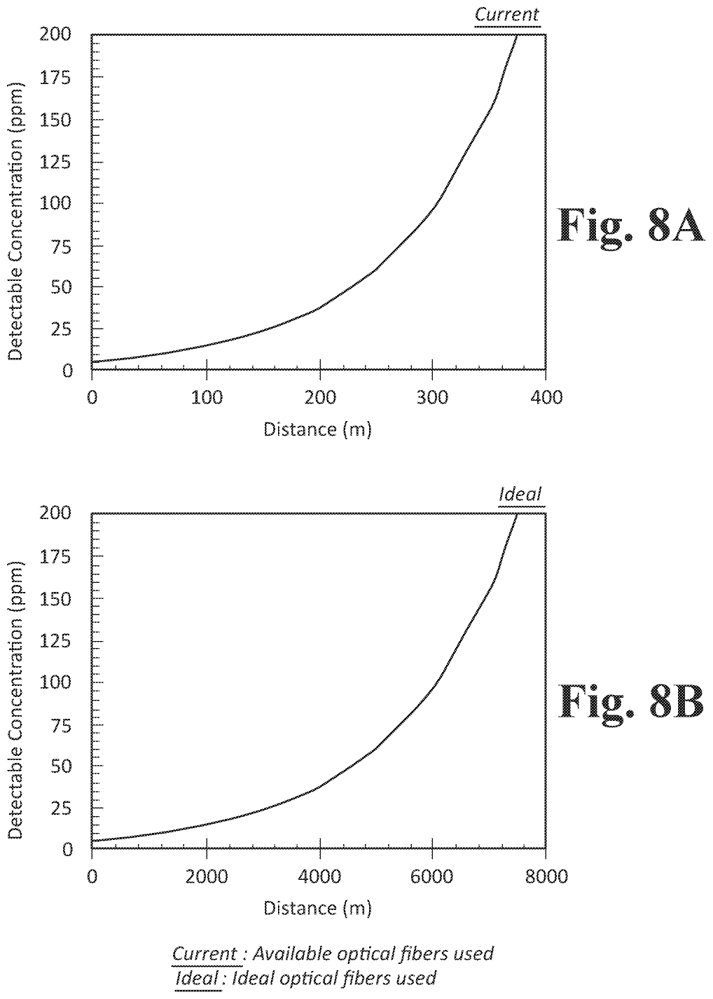

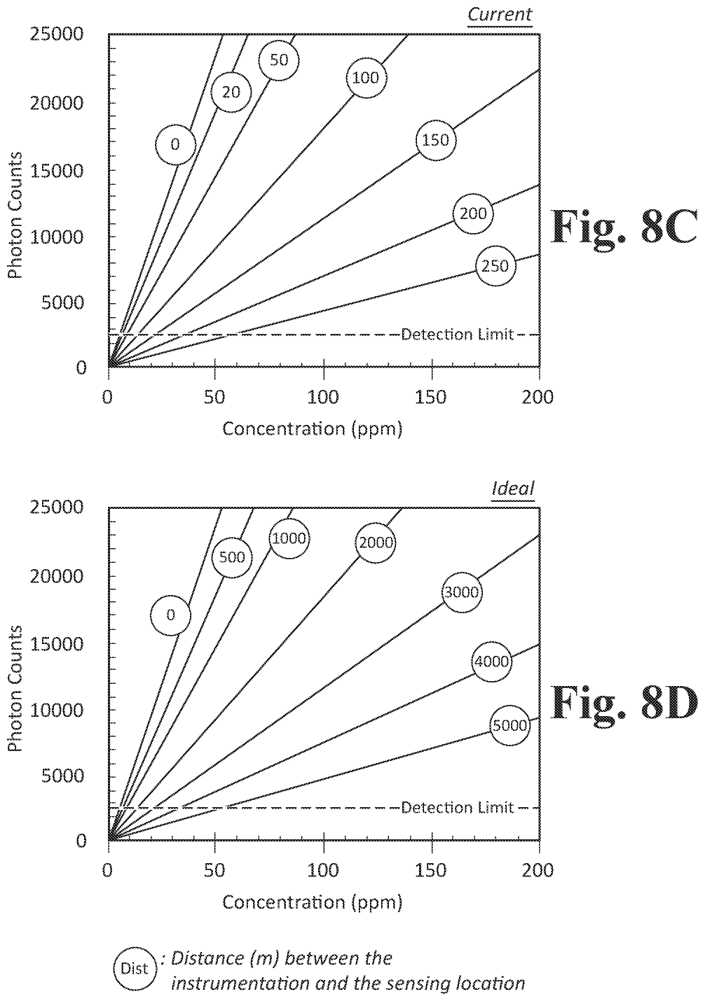

Based on this analysis, the detection limit for the system can be defined as a function of fiber length, as shown in FIGS. 8(a-1) and (a-2) for the current and ideal system, respectively. For example, 100 ppm nitrate-N could be detected and considered a valid test with the multiple-area process at about 305 m away using the current fiber and at about 1250 m away using the ideal fiber. In addition, it is possible to reframe the overall calibration curves relating observed counts to concentration for both the current and ideal systems as shown in FIGS. 8(b-1) and (b-2), respectively. The information in these curves can be interpreted two ways. First, if detection of a particular concentration is desired, by knowing the distance between the instrumentations and the sensing point, the number of Raman photons from the analyte that must arrive at the detector can be estimated. This information could be used to determine the system power and collection efficiency that must be achieved to reach the detection goal. On the other hand, if a given number of photon arrivals is known, the observed concentration of nitrate-N present at the sensing location can be estimated based on the distance between the observation equipment and the sensing location. Overall, the curves demonstrate that if the system is constructed with very low loss fibers and interfaces, multiplexed Raman spectroscopy may be achieved with field relevant detection sensitivity over great distance.

The developed understanding of losses contributed by each component in the prototype multiplexed system provides helpful insight to optimize the system. In one embodiment, the switch assembly is replaced by a single optical fiber and a series of well-aligned, indexed matched connectors. This avoids the Example's throughput limitation of 60%. Second, as the fibers and connectors in the Example contribute to significant attenuation (˜30 dB/km for single-mode fiber, ˜11 dB/km for multi-mode fiber, and ˜1.5 dB for each connector), connectors and changes of material interface may be chosen to limit/eliminate losses. Third, significant losses a new design occur when radiation enters or leaves a fiber due to material change, f/#mismatch, path misalignment, and other factors. Examples in the current multiplexed design include f/#mismatch between the excitation coupling objective lens and the excitation fiber, and the return fiber and the CCD. These losses are straightforward to address in other embodiments and system improvements can be achieved with improved component matching, use of index matching gel, and limitation of material interfaces.

Beyond altering the physical configuration of the multiplexing apparatus as described above to limit losses, it should be recognized that any system improvements that increase Raman generation and/or collection could also enhance system sensitivity over distance. Several approaches for tackling this task can again be found, including,
1. Increase the laser output, as the Raman scattering intensity increases when the incident laser intensity increases. There is of course an upper bound on the gains that can be realized in this manner, as increased excitation energy can also increase noise, and potentially damage the test sample. Nonetheless, the laser used in the Example employs modest per pulse energy relative to what is now commercially available, and thus there is likely room for improvement on this front.
2. Increase testing time, as the counts accumulated for any given analyte concentration increase with test duration. There is again a limit here as the base noise counts per unit of time cannot be overcome. However, the brief tests discussed in this section do not approach this limit, which is more likely encountered after ˜4 minutes (1.4 million PMT responses).

3. Improve system collection optics (with appropriate f/#matching), as these have significant influence of collection optic geometry on gathered Raman returns. Overall, the experimentation and analysis carried out in the Example highlights the significant advantages offered by a multiplexed fiber-coupled TRRS system design to provide unprecedented spatial reach for in-situ monitoring scenarios and emphasizes that desirable design improvements to reach field relevant performance are well within the realm of currently available technology.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

1. A spectroscopy system, comprising:
an optical excitation source;
an objective lens;
a mirror for redirecting optical excitation to the objective lens;
an optical switch;
an excitation beam optical fiber operationally connected to the objective lens and to the optical switch;
a plurality of probes;
a plurality of probe optical fibers, each respective probe optical fiber operationally connected to the optical switch and a respective probe;
a spectrometer;
wherein each respective probe is operationally connected to the spectrometer.

2. The spectroscopy system of claim 1 wherein the spectrometer is a charged coupled device.

3. The spectroscopy system of claim 1 wherein the optical excitation source is a laser.

4. The spectroscopy system of claim 1 wherein the optical switch is a multiplexer.

5. The spectroscopy system of claim 1 wherein the probes are Raman probes.

6. A Raman spectroscopy assembly, comprising:
a laser;
an objective lens;
a mirror for redirecting laser light positioned relative the laser to redirect light emitted from the laser to the objective lens;
a plurality of respective Raman probes;
a plurality of excitation beam optical fiber, each respective excitation beam optical fiber operationally connected to the objective lens and to a respective Raman probe;
an optical switch having an optical switch output port and a plurality of respective optical switch input ports;
a plurality of respective probe optical fibers, each respective probe optical fiber operationally connected to a respective optical switch input port and to a respective Raman probe;
a charge-coupled device spectrometer;
wherein the optical switch output port is operationally connected to the charge-coupled device spectrometer.

7. The Raman spectroscopy assembly of claim 6 wherein the optical switch is a demultiplexer.

8. A method of making Raman inquiries, comprising:
a) directing a laser beam to an objective lens;
b) directing laser light from the objective lens to a plurality of respective Raman probes;
c) making Raman inquiries of a plurality of samples, each respective sample inquired by a respective Raman probe; and
d) communicating the inquiry results of each respective Raman probe to a charge-coupled device spectrometer.

9. The method of claim 8 wherein b) further comprises:
b1) directing light from the objective lens to a multiplexing switch input; and
b2) directing light from a plurality of respective multiplexing switch output ports to a plurality of respective Raman probes, wherein each respective Raman probe is operationally connected to a respective switch output port by a respective optical fiber.

10. The method of claim 8 wherein d) further comprises:
d1) receiving a scattering signal from a sample via a Raman probe; and
d2) communicating received scattering signal from the Raman probe to the charge-coupled device spectrometer.

11. The method of claim 8 wherein d) further comprises:
d3) receiving a scattering signal from a respective sample via a respective Raman probe;
d2) communicating received scattering signal from each respective Raman probe to a respective demultiplexing switch input port; and
d3) sending a signal from a demultiplexing switch output port to the charge-coupled device spectrometer.

12. A method of making Raman inquiries, comprising:
e) directing a laser beam to an objective lens;
f) directing laser light from the objective lens to an optical switch via a laser source optical fiber;
g) directing laser light from the optical switch to a plurality of spaced Raman probes via a plurality of respective probe optical fibers;
h) making Raman inquiries of a plurality of samples, each respective sample inquired by a respective Raman probe; and
i) communicating the inquiry results of each respective Raman probe to a charge-coupled device spectrometer.
